(19) United States
(12) Patent Application Publication
(10) Pub. No.: US 2012/0080990 A1
(43) Pub. Date: Apr. 5, 2012

(54) TOP-LOADED REFRIGERATOR DOORS

(76) Inventors: Matthew William DAVIS, Prospect, KY (US); Richard Devos, Goshen, KY (US); Jeffrey Charles Mellinger, Louisville, KY (US); Daniel S. Renz, Louisville, KY (US)

(21) Appl. No.: 12/897,164

(22) Filed: Oct. 4, 2010

(51) Int. Cl. F25D 23/02; B23P 19/04

(52) U.S. Cl. 312/405; 29/428

(57) ABSTRACT

Top hinge-weight loaded refrigerator doors are provided. A refrigerator apparatus is provided that includes a body portion; and at least one door hinged to the body portion using at least one top hinge. The top hinge is a weight load bearing hinge.

### BACKGROUND OF THE INVENTION

The present disclosure relates generally to refrigerators, and more particularly, to methods and apparatus for mounting refrigerator doors. Household refrigerators typically include a fresh food storage compartment and a freezer storage compartment. The two compartments are typically arranged side-by-side or top-and-bottom, with each compartment separated by a mullion wall. Each compartment is typically closed using one or more drawers or access doors.

One problem with refrigerators, and especially with side-by-side or French door refrigerators, is that the doors must be aligned with one another or with the body of the appliance. The alignment is generally required for visual appeal and to ensure that the doors open and close properly. For example, a consumer's eye will typically reference the top of the two doors in a side-by-side refrigerator to determine if the doors are aligned.

Doors are typically mounted to the refrigerator using a hinge to support the weight of the door from the bottom (i.e., the bottom hinge is load bearing). In addition, the bottom hinge typically contains an adjustment mechanism that can be used to align the door relative to the refrigerator case. For example, the bottom hinge may include a threaded hinge pin to raise and/or lower the refrigerator door. Because of this load bearing requirement, the size of the bottom hinge becomes significant and may require a large gap between the fresh food storage compartment doors and the freezer storage compartment doors, for example, in a top-and-bottom configuration.

A need therefore exists for improved techniques for mounting refrigerator doors. More particularly, a need exists for improved techniques for mounting refrigerator doors that reduce the potential for misalignment by changing the location of the load bearing hinge. A further need exists for improved techniques for mounting refrigerator doors that address the sources of misalignment (such as door length and bottom hinge mounting hole locations) and thereby reduce the amount of adjustment needed.

### BRIEF DESCRIPTION OF THE INVENTION

As described herein, the exemplary embodiments of the present invention overcome one or more disadvantages known in the art. Generally, top hinge-load bearing refrigerator doors are provided.

According to one aspect of the invention, a refrigerator apparatus is provided that comprises a body portion; and at least one door hinged to the body portion using at least one top hinge. The top hinge is a weight-load bearing hinge.

According to another aspect of the invention, a method is provided for mounting at least one door to a refrigerator. The door is mounted by attaching the door to a body portion of the refrigerator using at least one top hinge. The top hinge is a weight-load bearing hinge.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 illustrates an exemplary refrigerator that includes a fresh food (FF) compartment and a freezer (FZ) compartment;

FIG. 2 is a free body diagram of the bottom hinge-weight loaded refrigerator doors of a conventional refrigerator;

FIG. 3 is a free body diagram of top hinge-weight loaded refrigerator doors of a refrigerator incorporating features of the present invention;

FIG. 4 is a front view and a side view of an exemplary door of FIG. 3;

FIG. 5 is a side view of an exemplary design for a top hinge incorporating features of the present invention;

FIG. 6 is a side view of an exemplary design for a bottom hinge incorporating features of the present invention; and

FIG. 7 illustrates an alternate door design incorporating features of the present invention.

### DETAILED DESCRIPTION OF THE EXEMPLARY EMBODIMENTS OF THE INVENTION

The present invention provides improved techniques for mounting refrigerator doors. As discussed hereinafter, the disclosed techniques reduce the potential for misalignment by changing the location of the load bearing hinge. In addition, the disclosed techniques address the sources of misalignment (such as door length and bottom hinge mounting hole locations) and thereby reduce the amount of adjustment that may be needed. As used herein, the term “load” of the door shall comprise the weight of the door itself and the weight of any contents stored in the door.

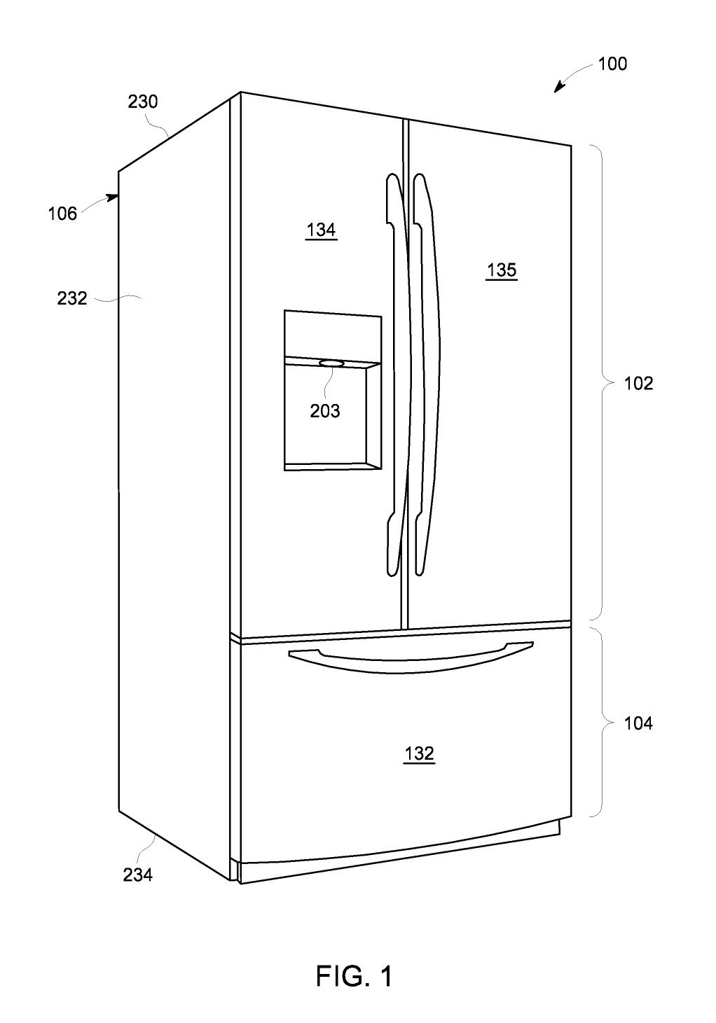

FIG. 1 illustrates an exemplary refrigerator 100 that includes a fresh food (FF) compartment 102 and a freezer (FZ) compartment 104. Although the refrigerator 100 is shown as a “bottom freezer” type, the teaching of the description set forth below is applicable to other types of refrigeration appliances, including but not limited to, side-by-side refrigerators. The present invention is therefore not intended to be limited to any particular type or configuration of a refrigerator.

The freezer compartment 104 and the fresh food compartment 102 are arranged in a bottom mount configuration where the freezer compartment 104 is disposed or arranged beneath or below the fresh food compartment 102. The fresh food compartment 102 is shown with French doors 134 and 135. However, a single access door can be used instead of the French doors 134, 135. The freezer compartment 104 is closed by one or more drawers or access doors 132.

The fresh food compartment 102 and the freezer compartment 104 are contained within a main body including an outer case 106. The outer case 106 comprises a top 230 and two sidewalls 232. A mullion (not shown in FIG. 1) connects the two sidewalls 232 to each other and separates the fresh food compartment 102 from the freezer compartment 104. The outer case 106 also has a bottom 234, which connects the two sidewalls 232 to each other at the bottom edges thereof, and a back (not shown).

The access door 132 and the French doors 134, 135 close access openings to the freezer compartment 104 and the fresh food compartment 102, respectively.

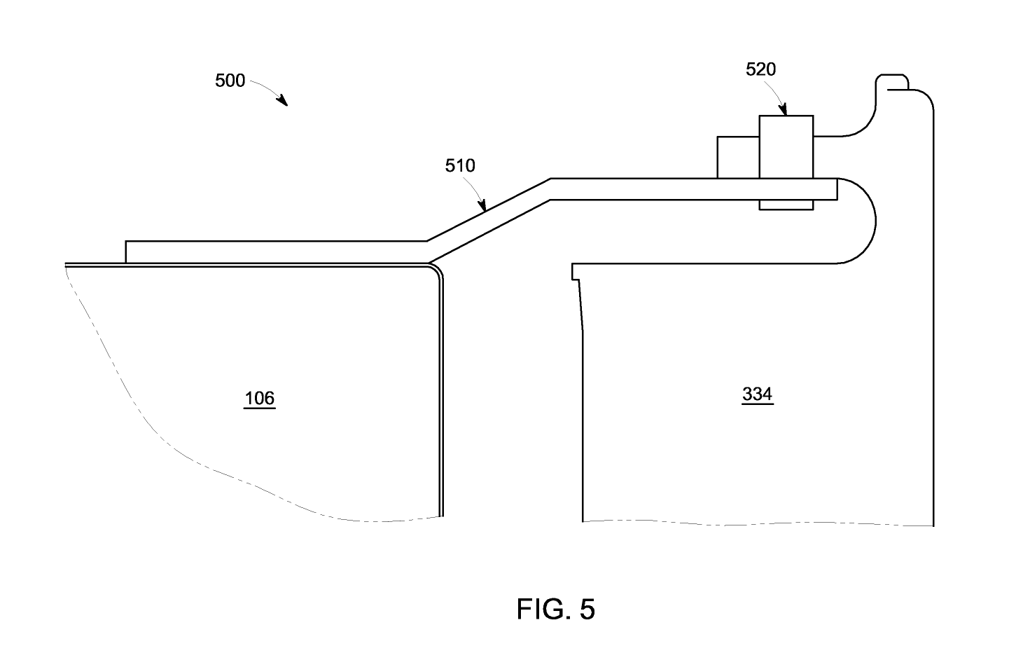

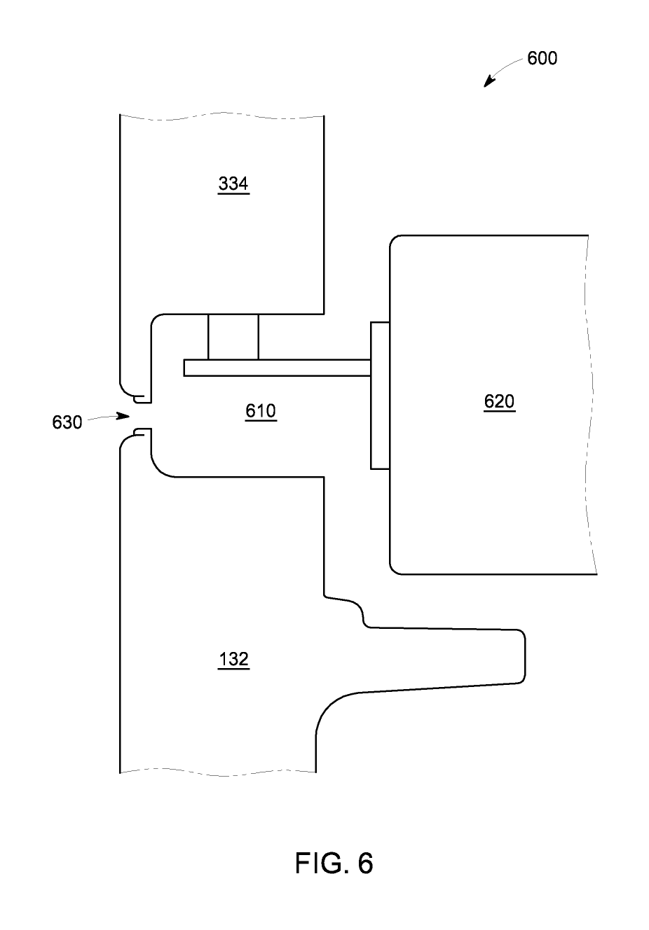

As discussed further below in conjunction with FIGS. 5 and 6, respectively, each French door 134, 135 is mounted to the main body by a top hinge and a corresponding bottom hinge, thereby being rotatable about its outer vertical edge between an open position for accessing the respective part of the fresh food compartment 102 and a closed position for closing the respective part of the fresh food compartment 102.

Similarly, when an access door 132 is used for the freezer compartment 104, it is rotatably attached to the main body in a known fashion. When a drawer is used for the freezer compartment, it is slidably received in the cavity defined by the sidewalls 232, the mullion and the bottom 234 in a known fashion.

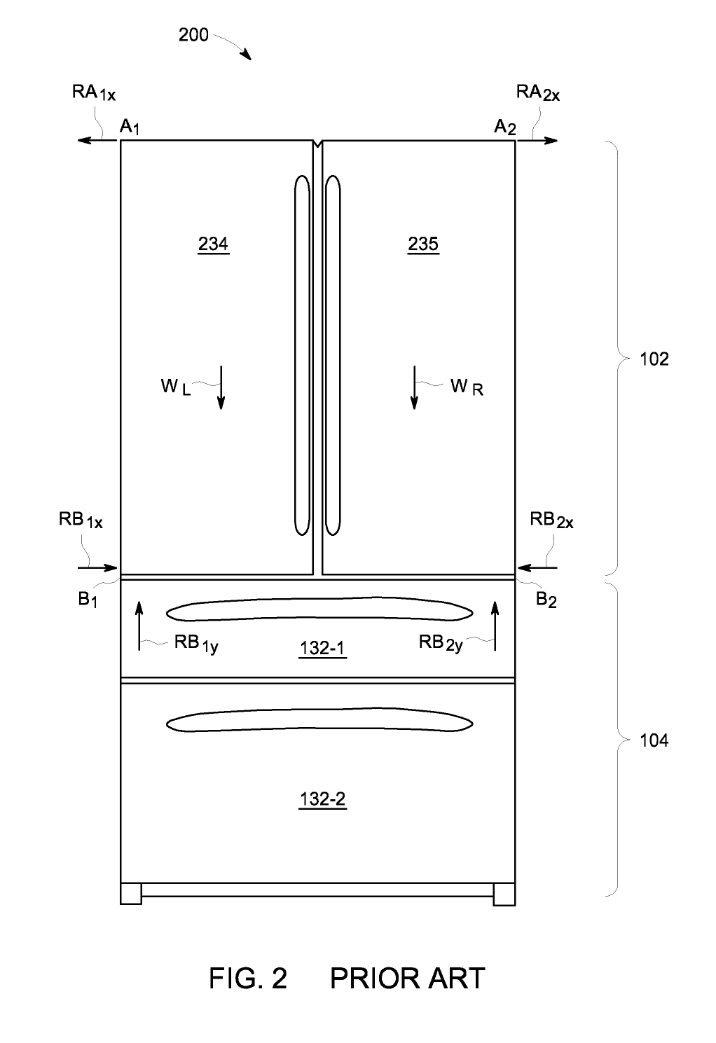

As previously indicated, the doors 134, 135 are typically mounted to the refrigerator 100 using a bottom hinge to support the weight of the door from the bottom. FIG. 2 is a free body diagram of the bottom-loaded refrigerator doors 234, 235 of a conventional refrigerator 200. The bottom hinge of each door 234, 235 is load bearing. In the embodiment shown in FIG. 2, the exemplary freezer compartment 104 of FIG. 1 comprises two doors 132-1, 132-2.

In the conventional design of FIG. 2, where the weight bearing load is at the bottom hinge, there is substantially no vertical component at the top of each door 234, 235. In other words, the top hinge comprises only a horizontal load, to keep the door from falling. As shown in FIG. 2, A1 is a point at the top left of the left door 234, A2 is a point at the top right of the right door 235, B1 is a point at the bottom left of the left door 234, and B2 is a point at the bottom right of the right door 235. In FIG. 2, the reaction force R, is indicated for a given point, such as point A1, in the vertical direction, y, and the horizontal direction, x. Thus, RA_{1X} is the reaction force at point A1 at the top left of the left door 234. Similarly, RB_{2Y} is the reaction force at point B2 at the bottom right of the right door 235.

As shown in FIG. 2, there are horizontal reaction forces, RA_{1X}, RA_{2X}, RB_{1X}, RB_{2X} at the four corners A1, A2, B1 and B2 of the refrigerator doors 234, 235. In addition, since the bottom hinge of each door 234, 235 is load bearing, there are vertical reaction forces, RB_{1Y}, RB_{2Y} at the two lower corners, B1 and B2, of the refrigerator doors 234, 235. Finally, since the top hinge of each door 234, 235 is not weight bearing, there are no vertical reaction forces at the two upper corners, A1 and A2, of the refrigerator doors 234, 235.

In the conventional design of FIG. 2, a larger gap is typically required between the bottom-loaded refrigerator doors 234, 235 of the upper FF compartment and the door(s) 132-1 of the FZ compartment, primarily due to the hinge requirement to support the weight of the FF doors 234, 235. This loading requirement, in addition to constrained space, forces the hinge to be larger than it would need to be if it was not load bearing. The present invention recognizes that a smaller hinge will allow the gap to be reduced and will improve the visual appeal of the refrigerator.

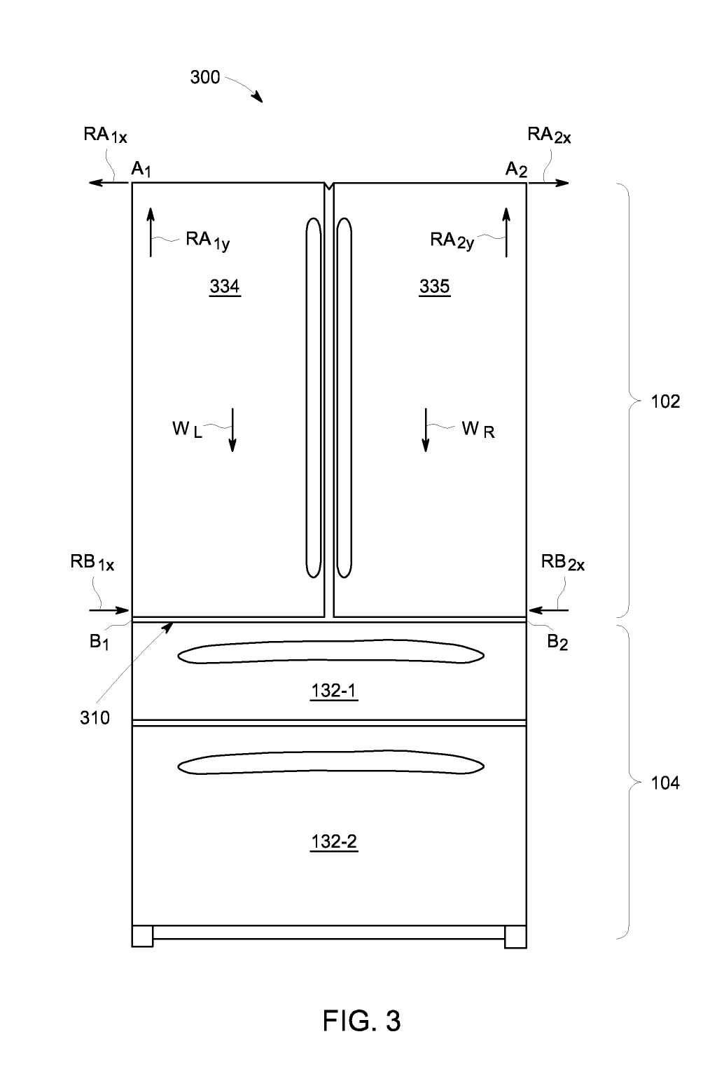

FIG. 3 is a free body diagram of top hinge-weight loaded refrigerator doors 334, 335 of a refrigerator 300 incorporating features of the present invention. According to one aspect of the present invention, the top hinge of each door 334, 335 is weight load bearing. In the embodiment shown in FIG. 3, the exemplary freezer compartment comprises two doors 132-1, 132-2.

In the embodiment of FIG. 3, the weight bearing load is at the top hinge and there is a vertical reaction force at the top of each door 334, 335. As shown in FIG. 3, A₁ is a point at the top left of the left door 334, A₂ is a point at the top right of the right door 335, B₁ is a point at the bottom left of the left door 334, and B₂ is a point at the bottom right of the right door 335. In FIG. 3, the reaction force R, is indicated for a given point, such as point A₁, in the vertical direction, y, and the horizontal direction, x. Thus, RA_{1X} is the reaction force at point A₁ at the top left of the left door 334. Similarly, RA_{1Y} is the reaction force at point A₁ at the top left of the left door 334.

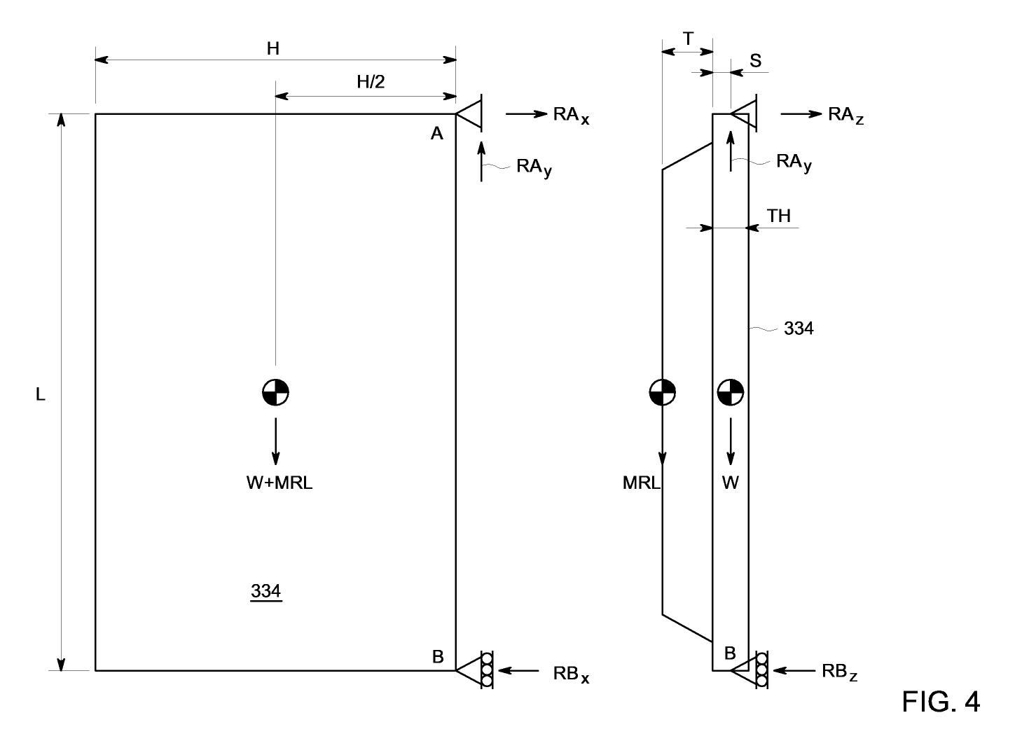

An aspect of the present invention transfers the load bearing hinge from the bottom to the top of the refrigerator 300. Thus, the only vertical reaction forces R_{Y} occur in FIG. 2 at the bottom hinge of each door 134, 135, with vertical reaction forces, RB_{1Y}, RB_{2Y} at the two lower corners, B₁ and B₂, of the refrigerator doors 134, 135. The vertical reaction forces R_{Y} occur in FIG. 3 substantially at the top hinge of each door 334, 335, with vertical reaction forces, RA_{1Y}, RA_{2Y} at the two upper corners, A₁ and A₂, of the refrigerator doors 334, 335. In addition, as shown in FIG. 3, there are horizontal reaction forces, RA_{1X}, RA_{2X}, RB_{1X}, RB_{2X} at the four corners A₁, A₂, B₁ and B₂ of the refrigerator doors 334, 335, in a similar manner to FIG. 2. The reaction forces seen by the doors 334, 335 are discussed further below in conjunction with FIG. 4.

The top-loaded design of the present invention allows a smaller hinge at the bottom of each door 334, 335. In other words, the present invention recognizes that moving the location of the load bearing hinge from the bottom of each door 334, 335 to the top of each door 334, 335 reduces the potential for misalignment. In addition, moving the location of the load bearing hinge from the bottom of each door 334, 335 to the top of each door 334, 335 addresses the sources of misalignment (such as door length and bottom hinge mounting hole locations) and thereby reduces the amount of adjustment that may be needed. The present invention recognizes that a smaller hinge at the bottom of each door 334, 335 will allow the gap 310 to be reduced and will improve the visual appeal of the refrigerator unit 300, because all hinges can be hidden. In addition, the top-loaded doors 334, 335 of the present invention provide more room and easier access for door alignment features.

FIG. 4 is a front view and a side view of an exemplary door 334 of FIG. 3. In FIG. 4, L indicates the door length, H indicates the door height, TH indicates the door thickness, S indicates the pivot point of the door, T indicates the thickness of the inner shelf mounted inside the door, W indicates the load from the weight of the door, MRL indicates the maximum reasonable load of the door from weight of the door contents (i.e., the weight of the food and other contents stored on the door), and R_{X}, R_{Y} and R_{Z} are the reaction forces in the respective direction.

As shown in FIG. 4, A is a point at the top of an exemplary door 334 and B is a point at the bottom of the exemplary door 334. In FIG. 4, the reaction force R, is indicated for a given point, such as point A, in the vertical direction, y, and the horizontal direction, x. Thus, RA_{X} and RA_{Y} are the horizontal and vertical reaction forces, respectively, at point A at the top of the door 334. Similarly, RB_{X} is the horizontal reaction force at point B at the bottom of the door 334. The top-loaded design of the present invention provides a vertical reaction force RA_{Y} at the top of the door 334.

In the notation of FIG. 4, point A is indicated as being a pinned connection, having no degrees of freedom, with no movement in the x, y or z direction. Likewise, point B is indicated as having the same constraints as point A with one degree of freedom, with movement only in the vertical direction.

From Newton's law, it can be shown that the reaction forces at A and B can be reduced to:

RBₓ=((W+MRL)*(H))/2L,

RAₓ=RBₓ,

RA_{y}=W+MRL;

RA_{z}=((MRL)(T+S))/L; and

RA_{z}=RB_{z}.

FIG. 5 is a side view of an exemplary design 500 for a top hinge incorporating features of the present invention. As shown in FIG. 5, the design 500 comprises a top hinge 510, a reversed adjustable hinge pin 520, a French Door 334, and the case 106. As indicated above, in accordance with the present invention, the top hinge 510 of each door 334, 335 is weight load bearing. The door 334 is positioned on the pin 520.

FIG. 6 is a side view of an exemplary design 600 for a bottom hinge incorporating features of the present invention. As shown in FIG. 6, the design 600 comprises a French door 334 supported by a bottom hinge 610, and a freezer door 132. The two compartments are arranged top-and-bottom in FIG. 6, with each compartment separated by a mullion wall 620.

As noted above, the top-loaded design of the present invention allows a smaller hinge 610 at the bottom of each door 334, 335. The present invention recognizes that the potential for misalignment and the corresponding required adjustments are reduced by moving the location of the load bearing hinge to the top of the refrigerator. In addition, a smaller hinge 610 at the bottom of each door 334, 335 will allow the gap 630 to be reduced and will improve the visual appeal of the refrigerator unit 300, because all hinges can be hidden. In addition, the top-loaded doors 334, 335 of the present invention provide more room and easier access for door alignment features.

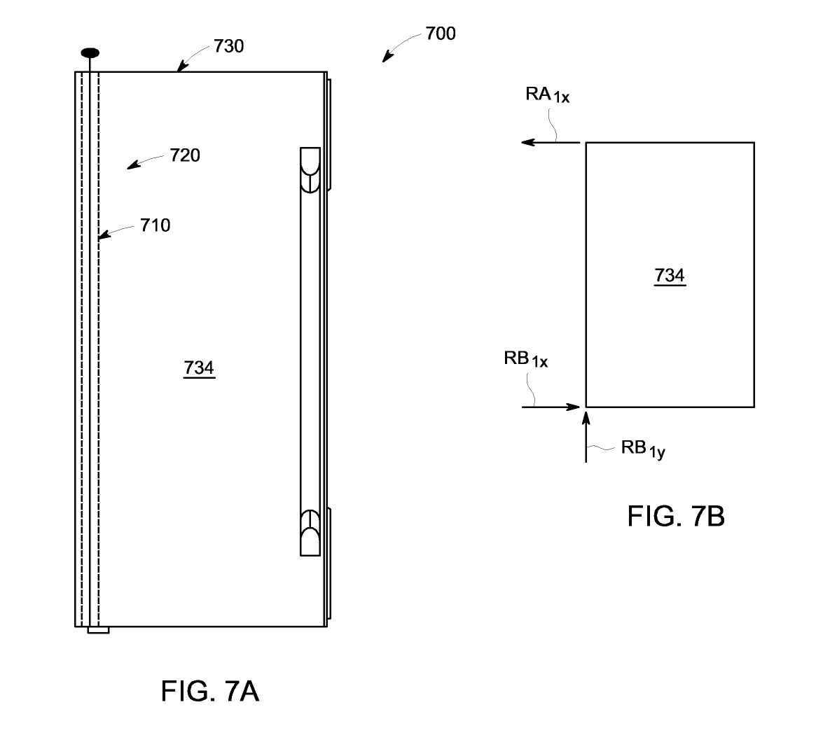

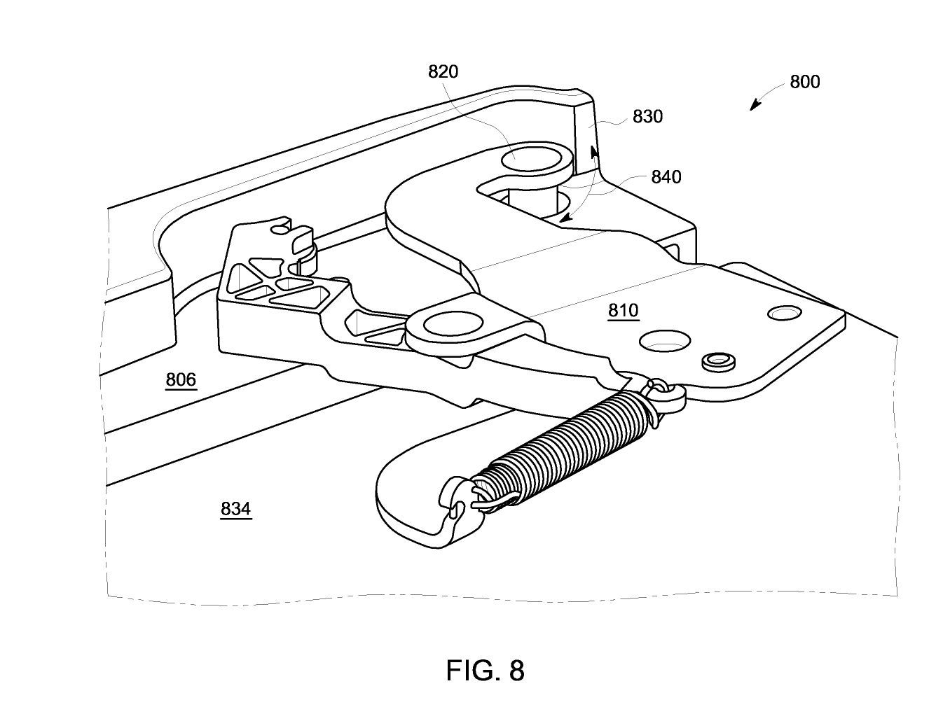

FIG. 7A illustrates an alternate door design 700 incorporating features of the present invention. FIG. 7B illustrates the reaction forces of the top-loaded door design 700 of FIG. 7A. As indicated above, in accordance with the present invention, each door 734 is top-loaded. In other words, the top hinge of each door 734 is load bearing. As shown in FIG. 7A, a wire 720 inside a conduit 710 is connected at the bottom of the door 734 and at the top hinge 730, to hold the weight of the door 734 from the bottom of the door 734 using a top-loaded hinge.

In this manner, as shown in FIG. 7B, the reaction forces on the top-loaded door 734 are maintained in the same position as in the conventional bottom-loaded configuration (which was discussed above in conjunction with FIG. 2). In other words, there is substantially no vertical component to the reaction force at the top of door 734 (i.e., the top hinge comprises only a horizontal load), and the reaction forces on the top-loaded door 734 comprise horizontal reaction force RA_{1X} at the top left of the door 734 and vertical and horizontal reaction forces RB_{1Y} and RB_{1X}, respectively, at the bottom left of the door 734.

It is noted that a tube, pipe, rod or other member can be employed in the conduit 710 to hold the weight of the door 734 from the bottom, instead of the wire 720, as would be apparent to a person of ordinary skill in the art. The conduit 710 is inside the door substantially at the hinge point.

FIG. 8 is a top view of an exemplary alternate design 800 for a top hinge incorporating features of the present invention. As shown in FIG. 8, the design 800 comprises a top hinge 810, a reversed adjustable hinge pin 820, a door 834, and the case 806. As indicated above, in accordance with the present invention, the top hinge 810 of each door 834 is weight load bearing. The top hinge 810 holds the weight of the door 834 and the top hinge is positioned on the pin 820. As shown in FIG. 8, the case 806 optionally includes an edge 830 that acts as a door stop and hits against the hinge 810 when the door 834 rotates about an axis 840.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”. The invention has been described with reference to the preferred embodiments. Obviously, modifications and alterations will occur to others upon reading and understanding the preceding detailed description. It is intended that the invention be construed as including all such modifications and alterations.

Thus, while there has been shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A refrigerator apparatus comprising:
a body portion; and
at least one door hinged to said body portion using at least one top hinge, wherein said at least one top hinge is a weight load bearing hinge.

2. The refrigerator apparatus of claim 1, wherein vertical reaction forces RY in said refrigerator apparatus occur substantially at said at least one top hinge.

3. The refrigerator apparatus of claim 1, further comprising at least one bottom hinge substantially hidden between an upper door and a lower door.

4. The refrigerator apparatus of claim 1, further comprising a door stop in proximity to said at least one top hinge.

5. The refrigerator apparatus of claim 1, further comprising a wire in a conduit in said at least one door to hold a weight of said at least one door from a bottom of said at least one door using said at least one top hinge.

6. The refrigerator apparatus of claim 5, wherein said wire is connected at a bottom of said at least one door and at said at least one top hinge.

7. The refrigerator apparatus of claim 1, wherein a position of said at least one door may be adjusted in a vertical direction.

8. A method for mounting at least one door to a refrigerator, said method comprising the steps of:
attaching said at least one door to a body portion of said refrigerator using at least one top hinge, wherein said at least one top hinge is a weight load bearing hinge.

9. The method of claim 8, wherein vertical reaction forces RY in said refrigerator occur substantially at said at least one top hinge.

10. The method of claim 8, further comprising the step of attaching said at least one door to said body portion using at least one bottom hinge.

11. The method of claim 10, wherein said at least one bottom hinge is substantially hidden between an upper door and a lower door.

12. The method of claim 8, further comprising the step of positioning a door stop in proximity to said at least one top hinge.

13. The method of claim 8, further comprising the step of running a wire in a conduit in said at least one door to hold a weight of said at least one door from a bottom of said at least one door using said at least one top hinge.

14. The method of claim 13, further comprising the step of connecting said wire at a bottom of said at least one door and at said at least one top hinge.

15. The method of claim 8, further comprising the step of adjusting a position of said at least one door in a vertical direction.
